(19) United States
(12) Patent Application Publication
(10) Pub. No.: US 2026/0284955 A1
(43) Pub. Date: Sep. 24, 2026

(54) PREFORM FOR A CONTAINER MADE OF PLASTICS MATERIAL

(71) Applicant: SIDEL PARTICIPATIONS, Octeville-sur-Mer (FR)

(72) Inventor: Mickaël LETESTU, OCTEVILLE- SUR-MER (FR)

(21) Appl. No.: 19/566,511

(22) Filed: Mar. 13, 2026

(30) Foreign Application Priority Data
Mar. 15, 2025 (FR) 2502623

(51) Int. Cl. B29C 49/00; B29L 31/00

(52) U.S. Cl. CPC B29C 49/071; B29C 2949/0715; B29C 2949/077; B29L 2031/7158

(57) ABSTRACT

Provided is a plastic preform for manufacturing containers by stretch-blow molding, having a body rotationally symmetrical about a vertical central axis, an outer wall, and an inner wall. The preform has an open neck that extends as a continuation from an upper end of the body, and a base which closes the body at a lower end. The base is rotationally symmetrical about the central axis and the body has, over a cone height Hc, from an annular collar towards the base, a conical outer wall and/or a conical inner wall, where the walls include means suitable for reducing the intensity of the refracted ray and/or for modifying the angle of said refracted ray, the incident radiation source being located outside said preform.

### CROSS-REFERENCE TO RELATED APPLICATIONS

This application claims the benefit of French Application No. FR2502623, filed Mar. 15, 2025, the entire contents of which is hereby incorporated herein by reference.

### BACKGROUND

Preforms for forming containers, particularly of polyethylene terephthalate (PET) and/or recycled polyethylene terephthalate (rPET) is generally performed by blow molding or stretch-blow molding of a preform. To form the container from the preform, the body and the base of the preform are first heated to a temperature above the glass transition temperature of the material (which, for PET, is about 80° C.). A pressurized fluid (typically air) is then injected into the preform, the body of which undergoes both axial and radial expansion until it reaches the desired shape of the container body. Generally, the axial expansion is carried out by stretching with the help of a rod. The heating is generally carried out in a heating unit (also called an oven) equipped with a plurality of infrared radiation sources to which the preforms are exposed. These sources are generally halogen lamps, which emit over a relatively wide spectrum including short-wave infrared (and possibly part of the medium-wave infrared), as well as at least part of the visible spectrum. The main drawbacks of halogen lamps are their low (or even non-existent) directivity and their relatively short service life.

An alternative heating solution can be laser oven technology using monochromatic (or quasi-monochromatic) radiation sources. Numerous tests of this new so-called laser oven technology, carried out on preforms of all shapes and sizes, have shown the presence in the preforms of zones of overheating of the material, which cannot be eliminated even by fine adjustment of the energy distribution of the sources, i.e. of the laser diodes. It has therefore become apparent that the silhouette and dimensions of the preforms need to be reworked having features to minimize refraction within the material, thereby improving the quality of heating. Existing preforms do not allow a satisfactory distribution of material to be obtained for all container formats and, ultimately, do not permit lightweighting of the containers manufactured from these preforms, while ensuring, in particular, good quality of said containers.

Furthermore, as a general rule, although the heating technology by means of a laser oven makes it possible to blow good quality bottles with “standard” market preforms, it may be affected by shape parameters commonly used in preform design, such as conical shapes, abrupt thickness variations and dome shapes. In fact, these preform shapes can disturb the monochromatic or quasi-monochromatic infrared radiation of the laser oven and also the localization of heating on the preforms and, ultimately, affect the bottle manufacturing process, potentially leading to a reduction in bottle quality.

Accordingly, it has been found that needs exist for a preform of simple and inexpensive design, which is particularly suitable for heating in a laser oven and provides improved material distribution for all container formats, thereby allowing lightweighting of the containers manufactured from this preform, while in particular ensuring good quality of said containers. It is to the provision of meeting these and other needs that the present invention is primarily directed.

### SUMMARY

Embodiments of the present disclosure provide for preforms, manufacturing containers from preforms, and molds for making the preforms.

An embodiment of the present disclosure includes a preform including at least a body that is rotationally symmetrical about a vertical central axis, the body having an outer wall and an inner wall, the radial distance between the outer wall and the inner wall defining a wall thickness; an open neck that extends as a continuation of the body from an upper end thereof, the neck being separated from the body by an annular collar; and a base that closes the body from a lower end thereof, the base being rotationally symmetrical about the central axis, and the body having, over a cone height Hc, from the annular collar towards the base, a conical outer wall and/or a conical inner wall, wherein the conical outer wall and/or the conical inner wall comprises, over all or part of the cone height Hc, a means suitable for reducing the intensity of the refracted ray and/or for modifying the angle of the refracted ray. An incident radiation source is located outside the preform.

An embodiment of the present disclosure also includes a method for manufacturing a container by blow molding or stretch-blow molding a preform as provided above, the including at least the following steps: providing a preform, heating the body of the preform by exposure to monochromatic or quasi-monochromatic infrared radiation of predetermined intensity; and forming the container by injecting a pressurized fluid into the preform preheated in this way.

An embodiment of the present disclosure also includes a mold for forming a preform as described above, the mold comprising a mold body having a lateral wall shaped to match an outer face of the body of the preform and a mold base shaped to match an outer face of the base of the preform and a core shaped to match an inner face of the preform.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is an elevational sectional view of a preform for manufacturing a container according to various example embodiments;

FIG. 2 is a schematic representation of the inner wall of the body of a preform, at a frustoconical portion of said body of the preform, provided with means suitable for reducing the intensity of the refracted ray, according to various example embodiments;

FIG. 3 is a schematic representation of the inner wall of the body of a preform, at a frustoconical portion of said body of the preform, provided with means suitable for modifying the angle of the refracted ray;

FIG. 4 is an elevational sectional view of an alternative embodiment of the preform for manufacturing a container according to various example embodiments;

FIG. 5 is a schematic representation illustrating the manufacture of a container from a preform according to various example embodiments; and

FIG. 6 is a sectional view of a mold allowing the preform to be formed according to various embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C, and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

### General Discussion

In accordance with the purpose(s) of the present disclosure, as embodied and broadly described herein, embodiments of the present disclosure, in some aspects, relate to

In general, embodiments of the present disclosure relate to the manufacture of containers from preforms, in particular made of polyethylene terephthalate (PET) and/or recycled polyethylene terephthalate (rPET). More specifically, the invention provides for a preform intended for forming a container by blow molding or stretch-blow molding, within a mold shaped to match the container or in a free-blow manner (i.e. in the absence of a mold).

It is known in the art that a container typically comprises a lateral wall which is generally rotationally symmetrical about a central axis, a neck which extends as a continuation of the lateral wall and through which the container is intended to be filled and emptied, and a base which extends transversely from a lower end of the body and by which the container is intended to rest on a flat surface.

Furthermore, a preform typically comprises a substantially cylindrical body (intended to form the lateral wall of the container), an open neck which extends as a continuation of the body from an upper end thereof and is separated from the body by a collar (the neck remaining unchanged during the container forming process), and a base which closes the body at a lower end thereof (and is intended to form the base of the container).

To form the container from the preform, the body and the base of the preform are first heated to a temperature above the glass transition temperature of the material (which, for PET, is about 80° C.). A pressurized fluid (typically air) is then injected into the preform, the body of which undergoes both axial and radial expansion until it reaches the desired shape of the container body. Generally, the axial expansion is carried out by stretching with the help of a rod.

Said heating is generally carried out in a heating unit (also called an oven) equipped with a plurality of infrared radiation sources to which the preforms are exposed. These sources are generally halogen lamps, which emit over a relatively wide spectrum including short-wave infrared (and possibly part of the medium-wave infrared), as well as at least part of the visible spectrum. The main drawbacks of halogen lamps are their low (or even non-existent) directivity and their relatively short service life.

In order to overcome these drawbacks, the Applicant has developed an alternative heating technology based on the use of monochromatic (or quasi-monochromatic) radiation sources, which offer better directivity and a longer service life; see, for example, European patent application EP 2 720 842 (WO2012172250) (Sidel Participations), which describes a method for heating preforms by means of an array of vertical-cavity surface-emitting laser diodes (VCSELs).

Numerous tests of this new so-called laser oven technology, carried out on preforms of all shapes and sizes, have shown the presence in the preforms of zones of overheating of the material, which cannot be eliminated even by fine adjustment of the energy distribution of the sources, i.e. of the laser diodes. It has therefore become apparent that the silhouette and dimensions of the preforms need to be reworked.

In this respect, the Applicant has already proposed a preform which, when exposed to monochromatic or quasi-monochromatic infrared radiation, can be heated in a relatively homogeneous manner, i.e. without exhibiting undesired local overheating zones. A preform of this kind adapted to a laser oven is described in particular in document WO2017/103372 A1 filed by the Applicant.

The aforementioned document WO2017/103372 A1 describes a container preform made of plastics material comprising a body which is rotationally symmetrical about a central axis; an open neck which extends as a continuation of the body and is separated therefrom by a radially projecting collar; and a base which closes the body opposite the neck; wherein the body has a concave portion in axial section and in which: B≤0.9 A and 0.5 C<C′<0.95 C, where A is the overall diameter of the body, measured beneath the collar; B is the external diameter of the base, measured at its junction with the body; C is the combined height of the body and the base, measured from the collar; C′ is the height, measured axially, of the concave portion of the body; and the concave portion has, in axial section, on an outer face, an external radius of curvature RE such that 1.5 C≤RE≤10 C.

These features help to minimize refraction within the material, thereby improving the quality of heating.

However, these preforms do not allow a satisfactory distribution of material to be obtained for all container formats and, ultimately, do not permit lightweighting of the containers manufactured from these preforms, while ensuring, in particular, good quality of said containers.

Furthermore, as a general rule, although the heating technology by means of a laser oven makes it possible to blow good quality bottles with “standard” market preforms, it may be affected by shape parameters commonly used in preform design, such as conical shapes, abrupt thickness variations and dome shapes.

In fact, these preform shapes disturb the monochromatic or quasi-monochromatic infrared radiation of the laser oven and also the localisation of heating on the preforms and, ultimately, affect the bottle manufacturing process, potentially leading to a reduction in bottle quality.

One object of the disclosure is therefore to remedy all or some of these drawbacks by providing a preform of simple and inexpensive design, which is particularly suitable for heating in a laser oven and provides improved material distribution for all container formats, thereby allowing lightweighting of the containers manufactured from this preform, while in particular ensuring good quality of said containers.

To this end, and in accordance with the disclosure, there is provided a preform for manufacturing containers by stretch-blow molding, made of plastics material, comprising at least a body which is rotationally symmetrical about a vertical central axis (X), said body having an outer wall and an inner wall, the radial distance between the outer wall and the inner wall defining a wall thickness, an open neck which extends as a continuation of the body from an upper end thereof, said neck being separated from the body by an annular collar, and a base which closes the body from a lower end thereof, said base being rotationally symmetrical about the central axis (X), and said body having, over a height, referred to as the cone height Hc, from the annular collar towards the base, a conical outer wall and/or a conical inner wall; said preform being characterized in that said conical outer wall and/or said conical inner wall comprises, over all or part of said cone height Hc, means suitable for reducing the intensity of the refracted ray and/or for modifying the angle of said refracted ray, the incident radiation source being located outside said preform.

Preferably, said means suitable for reducing the refracted radiation and/or modifying the angle of the refracted ray comprise or consist of at least one surface condition of the conical outer wall and/or of the conical inner wall.

According to a first embodiment, said surface condition of the conical outer wall and/or of the conical inner wall comprises or consist of a matte surface of the conical outer wall and/or of the conical inner wall.

Preferably, the mattesurface of the conical outer wall and/or of the conical inner wall has a roughness of between 0.1 and 1.5 μm.

According to a second embodiment, said surface condition of the conical outer wall and/or of the conical inner wall comprises or consist of a stepped surface of the conical outer wall and/or of the conical inner wall, each step comprising two segments.

Preferably, each step comprises two segments extending substantially perpendicularly to one another.

Furthermore, each step comprises two segments extending substantially perpendicularly to one another, a first segment extending substantially perpendicularly to the axis of revolution of the preform and a second segment extending substantially parallel to the axis of revolution.

In addition, each segment of each step can be planar.

Alternatively, at least one segment of each step is concave or convex.

According to another embodiment, said surface condition of the conical outer wall and/or of the conical inner wall comprises or consist of a mattesurface of the conical outer wall and/or of the conical inner wall and a stepped surface of the conical outer wall and/or of the conical inner wall.

Preferably, the means suitable for reducing the intensity of the refracted ray and/or for modifying the angle of said refracted ray of said conical outer wall and/or said conical inner wall extend over the entire cone height Hc.

Another object of the invention relates to a method for manufacturing a container by blow molding or stretch-blow molding, comprising at least the following steps: providing a preform according to the invention; heating the body of the preform by exposure to monochromatic or quasi-monochromatic infrared radiation of predetermined intensity; and forming the container by injecting a pressurized fluid into the preform preheated in this way.

Furthermore, the method comprises, between the heating step and the forming step, a step of introducing the preform into a mold shaped to match the container.

A final object of the disclosure relates to a mold for forming a preform as described herein, comprising a mold body having a lateral wall shaped to match an outer face of the body of the preform and a mold base shaped to match an outer face of the base of the preform and a core shaped to match an inner face of the preform.

Turning now to the drawings, exemplary embodiments are described in detail.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

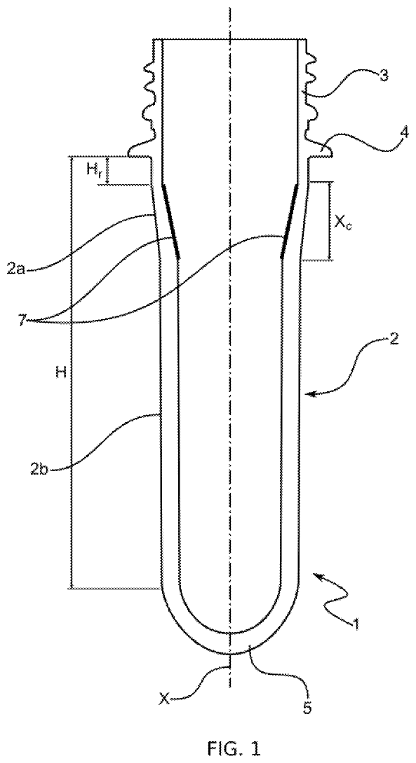

FIG. 1 shows a preform 1 made of plastics material such as PET (polyethylene terephthalate) and/or rPET (recycled polyethylene terephthalate), from which a container is intended to be formed by blow molding or stretch-blow molding.

Each preform 1 comprises, firstly, a body 2 which extends in a rotationally symmetrical manner about a central axis X, said body 2 of the preform 1 being intended to form a body and a shoulder of the container.

Each preform 1 comprises, secondly, an open neck 3 which extends as a continuation of the body 2 from an upper end thereof. The neck 3 has its final shape, which it is intended to retain throughout the forming process and service life of the container.

The neck 3 is advantageously separated from the body 2 by a collar 4 projecting radially, by which the preform 1 (and subsequently the container) is suspended (or more generally held) during various conveying, preform 1 heating or container forming operations and then, respectively, during filling, capping and labelling of the preform.

Each preform 1 comprises, thirdly, a base 5 which closes the body 2 from a lower end 6 thereof, i.e. the material of the base 5 extends from the lower end 6 of the body 2 radially towards the central axis X so as to close the preform 1 opposite the neck 3. The base 5 is rotationally symmetrical about the central axis X, i.e. it is invariant in any longitudinal sectional plane (in other words, any plane passing through the central axis X).

Hence, said preform according to the invention for manufacturing containers by stretch-blow molding, made of plastics material, comprises at least a body which is rotationally symmetrical about a vertical central axis (X), said body having an outer wall and an inner wall, the radial distance between the outer wall and the inner wall defining a wall thickness, an open neck which extends as a continuation of the body from an upper end thereof, said neck being separated from the body by an annular collar, and a base which closes the body from a lower end thereof, said base being rotationally symmetrical about the central axis (X).

The body comprises a first portion, referred to as the upper frustoconical portion 2a, over a height Hc, referred to as cone height, from the collar 4 towards the base 5, and a second portion, referred to as the lower substantially cylindrical portion 2b, from the lower end of the upper frustoconical portion 2a to the base 5 of the preform 1.

The aforementioned conical inner wall, i.e. the inner wall of the body 2 in the region of the upper frustoconical portion 2a, comprises means 7 suitable for reducing the intensity of the refracted ray and/or for modifying the angle of said refracted ray, the incident radiation source being located outside said preform 1, said incident radiation source not being shown in FIG. 1 and said means 7 being shown schematically by a thicker line.

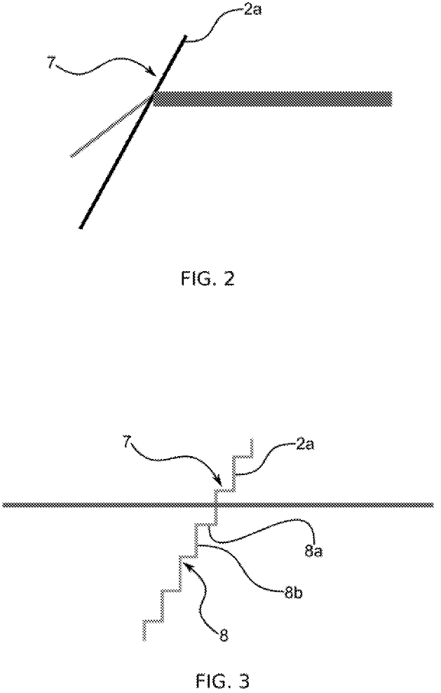

According to a first embodiment, with reference to FIGS. 1 and 2, said means 7 comprise or consist of at least one surface condition of the conical inner wall suitable for reducing the refracted radiation. In this specific embodiment, said surface condition 7 comprises or consist of a matte surface of said conical inner wall.

Preferably, said matte surface of the conical inner wall has a roughness of between 0.1 and 1.5 μm. Moreover, said matte surface of the conical inner wall may be obtained by any chemical process, for example by application of an acid, and/or by any mechanical process, such as sandblasting, well known to a person skilled in the art.

Furthermore, in this specific embodiment, the means 7 suitable for reducing the intensity of the refracted ray, in this case said matte surface, of said conical inner wall extend over the entire cone height Hc. However, it is clearly understood that said means 7 may extend only over part of said height Hc, whether continuously or not, without thereby departing from the scope of the invention.

It is self-evident that the matte surface 7 may be replaced by any other means suitable for reducing the intensity of the refracted ray, without thereby departing from the scope of the invention.

According to a second embodiment, with reference to FIGS. 1 and 3, said means 7 comprise or consist of at least one surface condition of the conical inner wall suitable for modifying the angle of said refracted ray of said conical inner wall. In this specific embodiment, said surface condition 7 comprises or consists of a stepped surface 8 of the conical inner wall, each step 8 comprising two segments 8a and 8b.

More particularly, in this specific embodiment, each step 8 comprises two segments 8a and 8b extending substantially perpendicularly to one another: a first segment 8a extending substantially perpendicularly to the axis X of revolution of the preform 1 and a second segment 8b extending substantially parallel to the axis of revolution, each segment 8a, 8b of each step 8 being planar.

It is clearly understood that said segments 8a and 8b of each step 8 need not extend perpendicularly to one another and/or need not extend, respectively, perpendicularly to and parallel with the axis X of revolution of the preform, without thereby departing from the scope of the invention.

Moreover, it is self-evident that at least one segment of each step 8 may be concave or convex, without thereby departing from the scope of the invention.

Furthermore, in this specific embodiment, the means 7 suitable for modifying the angle of said refracted ray of said conical inner wall extend over the entire cone height Hc. However, it is quite clear that said means 7 may extend over only part of said height Hc, whether continuously or not, without thereby departing from the scope of the invention.

It is self-evident that the stepped surface 8 of the conical inner wall, which is similar to a Fresnel lens, may be replaced by any means suitable for modifying the angle of said refracted ray, without thereby departing from the scope of the invention.

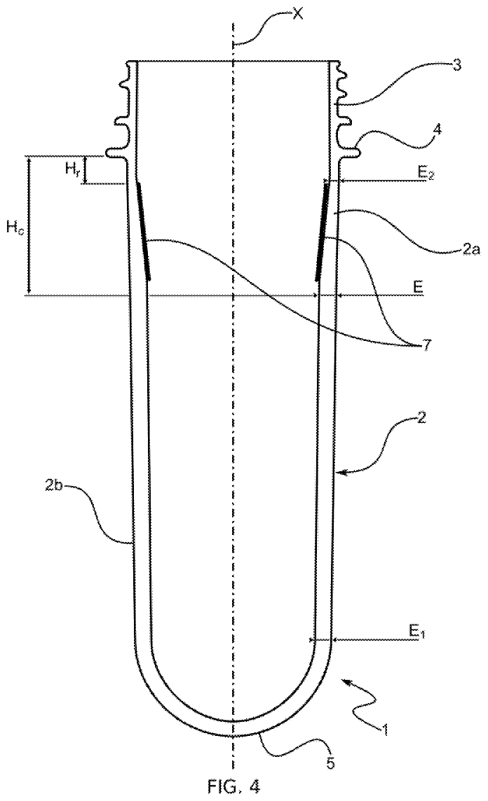

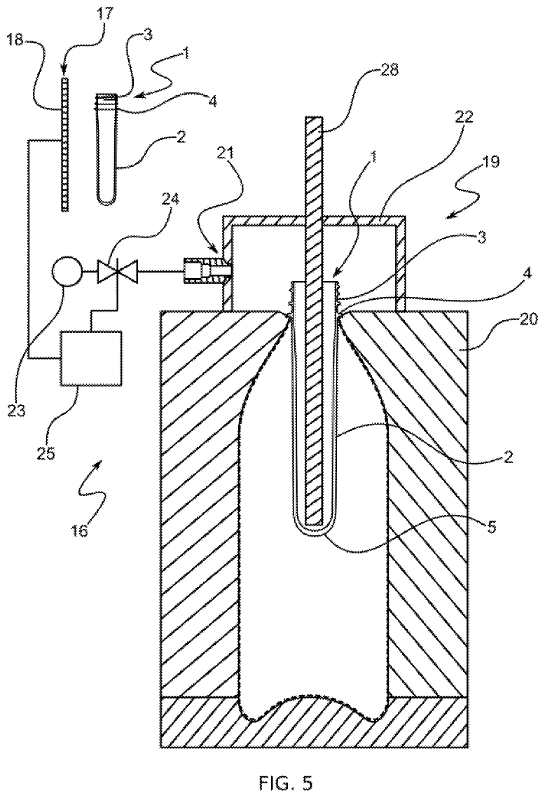

According to an alternative embodiment of the preform 1 according to the invention, with reference to FIG. 4, said preform 1 being made of a plastics material such as PET (polyethylene terephthalate) and/or rPET (recycled polyethylene terephthalate) and being intended for the manufacture of a container formed by blow molding or stretch-blow molding, each preform 1 comprises, in the same manner as previously, firstly a body 2 which extends in a rotationally symmetrical manner about a central axis X. According to an advantageous embodiment suitable for most applications, the body 2 is substantially cylindrical.

Each preform 1 comprises, secondly, an open neck 3 which extends as a continuation of the body 2 from an upper end thereof. The neck 3 has its final shape, which it is intended to retain throughout the forming process and service life of the container.

The neck 3 is advantageously separated from the body 2 by a collar 4 projecting radially, by which the preform 1 (and subsequently the container) is suspended (or more generally held) during various conveying, preform heating or container forming operations and then, respectively, during filling, capping and labelling of the preform.

Each preform 1 comprises, thirdly, a base 5 which closes the body 2 from a lower end 6 thereof, i.e. the material of the base 5 extends from the lower end 6 of the (substantially cylindrical) body 2 radially towards the central axis X so as to close the preform 1 opposite the neck 3. The base 5 is rotationally symmetrical about the central axis X, i.e. it is invariant in any longitudinal sectional plane (in other words, any plane passing through the central axis X).

Hence, said preform 1 according to the invention for manufacturing containers by stretch-blow molding, made of plastics material, comprises at least a body 2 which is rotationally symmetrical about a vertical central axis (X), said body 2 having an outer wall and an inner wall, the radial distance between the outer wall and the inner wall defining a wall thickness.

The aforementioned body 2 has a substantially cylindrical shape in which the wall thickness increases from the collar 4, the wall thickness of the body beneath the collar being equal to E2 at a reference height Hr beneath the collar; towards the base 5, over a height referred to as the cone height Hc, the wall thickness of the body 2 at said cone height Hc is equal to E, and the wall thickness of the body at the lower end of said body is equal to E1.

The aforementioned preform 1 differs from that described previously in that, over the cone height Hc, the mean external diameter of the body 2 is constant from the collar 4 towards the lower end 6 of the body 2 and the mean internal diameter decreases from the collar 4 towards the lower end 6 of the body 2, thereby providing a frustoconical shape for the inner wall of the body 2 over said height Hc.

In addition, the base 5 of the preform 1 has a substantially hemispherical shape. However, it is clearly understood that the base 5 of the preform may have any shape without thereby departing from the scope of the invention.

The aforementioned body comprises a first portion, referred to as the upper frustoconical portion 2a, over a height Hc, referred to as cone height, from the collar 4 towards the base 5, and a second portion, referred to as the lower substantially cylindrical portion 2b, from the lower end of the upper frustoconical portion 2a to the base 5 of the preform 1.

The conical inner wall, i.e. the inner wall of the body 2 in the region of the upper frustoconical portion 2a, comprises means 7 suitable for reducing the intensity of the refracted ray and/or for modifying the angle of said refracted ray, the incident radiation source being located outside said preform 1, said incident radiation source not being shown in FIG. 4 and said means 7 being shown schematically by a thicker line.

In the same manner as previously, according to a first embodiment, with reference to FIGS. 4 and 2, said means 7 comprise or consist of at least one surface condition of the conical inner wall suitable for reducing the refracted radiation. In this specific embodiment, said surface condition 7 comprises or consist of a matte surface of said conical inner wall.

Preferably, said matte surface of the conical inner wall has a roughness of between 0.1 and 1.5 μm. Moreover, said matte surface of the conical inner wall may be obtained by any chemical process, for example by application of an acid, and/or by any mechanical process, such as sandblasting, well known to a person skilled in the art.

Moreover, in this specific embodiment, the means 7 suitable for reducing the intensity of the refracted ray, in this case said matte surface, of said conical inner wall extend over the entire cone height Hc. However, it is clearly understood that said means 7 may extend only over part of said height Hc, whether continuously or not, without thereby departing from the scope of the invention.

It is self-evident that the matte surface 7 may be replaced by any other means suitable for reducing the intensity of the refracted ray, without thereby departing from the scope of the invention.

According to a second embodiment, with reference to FIGS. 4 and 3, said means 7 comprise or consist of at least one surface condition of the conical inner wall suitable for modifying the angle of said refracted ray of said conical inner wall. In this specific embodiment, said surface condition 7 comprises or consist of a stepped surface 8 of the conical inner wall, each step 8 comprising two segments 8a and 8b.

More particularly, in this specific embodiment, each step 8 comprises two segments 8a and 8b extending substantially perpendicularly to one another: a first segment 8a extending substantially perpendicularly to the axis X of revolution of the preform 1 and a second segment 8b extending substantially parallel to the axis of revolution, each segment 8a, 8b of each step 8 being planar.

It is clearly understood that said segments 8a and 8b of each step 8 need not extend perpendicular to one another and/or need not extend, respectively, perpendicularly to and parallel with the axis X of revolution of the preform, without thereby departing from the scope of the invention.

Moreover, it is self-evident that at least one segment of each step 8 may be concave or convex, without thereby departing from the scope of the invention.

Furthermore, in this specific embodiment, the means 7 suitable for modifying the angle of said refracted ray of said conical inner wall extend over the entire cone height Hc. However, it is quite clear that said means 7 may extend over only part of said height Hc, whether continuously or not, without thereby departing from the scope of the invention.

It is self-evident that the stepped surface 8 of the conical inner wall, which is similar to a Fresnel lens, may be replaced by any means suitable for modifying the angle of said refracted ray, without thereby departing from the scope of the invention.

It should be noted that the conical inner wall may simultaneously comprise a stepped surface 8 and a matte surface, in order to reduce the intensity of the refracted ray and to modify the angle of said refracted ray.

Moreover, it will be observed that the conical outer wall of the body of the preform 1, i.e. the outer wall of the body 2 of the preform 1 in the region of the upper conical portion 2a, may also comprise means suitable for reducing the intensity of the refracted ray and/or modifying the angle of said refracted ray as described above.

Hence, said conical outer wall and/or said conical inner wall may comprise, over all or part of said cone height Hc, means suitable for reducing the intensity of the refracted ray and/or for modifying the angle of said refracted ray.

Moreover, FIG. 5 very schematically shows an installation 16 for manufacturing a container from a preform 1, as described above.

This installation 16 comprises a heating unit 17 provided with a plurality of sources 18 of monochromatic or quasi-monochromatic electromagnetic radiation in the infrared range.

In theory, a monochromatic source is an ideal source emitting a sinusoidal wave of a single frequency. In other words, its frequency spectrum comprises or consist of a single line of zero spectral width (Dirac).

A source of this kind does not exist in practice; a real source is at best quasi-monochromatic, i.e. its frequency spectrum extends over a band of small but non-zero spectral width, centred on a main frequency at which the radiation intensity is maximal.

The sources 18 are preferably arranged in an array; they are, for example, VCSEL-type laser diodes, each emitting radiation with a power of some tens of milliwatts at a wavelength in the order of 1 μm.

The installation 16 also comprises a forming unit 19 including at least one mold 20 shaped to match the container. In practice, the forming unit 19 may comprise a series of molds 20 mounted on a rotary carousel. The forming unit 19 comprises, for each mold, an injection device 21 including a nozzle 22 configured to be applied in a sealed manner against an upper face of the mold 20 and connected to a source 23 of pressurized fluid (e.g. air) via a distributor 24 (e.g. a solenoid valve). The installation furthermore comprises a control unit 25 connected to the sources 23 and to the distributor 24 to control, respectively, the pressure setting and their opening and closing.

In the illustrated example, the forming unit 19 further comprises, for each mold 20, a rod 26 mounted so as to slide relative to the mold 20, in order to ensure, simultaneously with the blowing, stretching of the preform 1.

Hence, the following procedure is followed to form a container.

First, a preform 1 as described above is supplied, for example from a container in which identical preforms are stored.

The body 2 and the base 5 of the preform 1 are then heated in the heating unit 17 by exposure to monochromatic or quasi-monochromatic infrared radiation of predetermined intensity emitted by the sources 18. During heating, the preform 1 is rotated about its axis X, in order to ensure uniform exposure of its body 2 and its base 5 to the radiation.

In view of its shape and dimensions, as described above, it is observed that the preform 1 refracts little of the radiation that it receives. This results in better energy distribution within the material, improved control of heating and better correspondence between the power profile set at the sources 18 and the actual thermal profile observed (e.g. by means of a thermal camera) on the preform 1.

The preform 1 heated in this manner is then introduced into the mold 20 and the container is formed by injecting a pressurized fluid (e.g. air) from the source 23 into the preform 1.

The forming by injection may comprise a step of axial stretching of the preform 1 by means of a rod (cf. rod 26 in FIG. 5).

As an alternative, the forming may be carried out freely, that is to say without a mold.

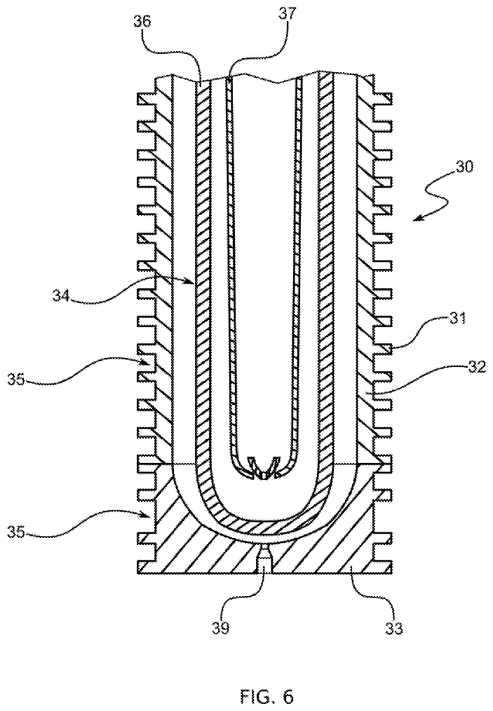

Moreover, FIG. 6 partially shows a mold 30 for forming a preform 1 as described above.

More specifically, the illustrated mold 30 is advantageously designed to enable the manufacture of the preform 1 shown in FIG. 1, by simple injection of a plastics material (typically PET and/or rPET). A mold 30 of this kind comprises, on the one hand, a mold body 31 having a lateral wall 32 shaped to match the outer face of the preform 1 in the region of the body 2 and a mold base 33 shaped to match the outer face of the preform 1 in the region of the base 7, and, on the other hand, a core 34 shaped to match the inner face of the preform 1.

The mold body 31 and the mold base 33 are fixed, whereas the core 34 is translatable relative thereto so as to allow the preform 1, once formed, to be removed and stripped.

As shown in FIG. 6, the lateral wall 32 and the mold base 33 are provided, on their periphery, with grooves 35 which, together with an outer shell (not shown), form circulation channels for a refrigerant fluid (such as water) intended to cool the preform 1, via its outer face, immediately after it has been formed.

As can also be seen in FIG. 6, the core 34 is provided with a hollow outer shell 36 shaped to match the inner face of the preform 1, and with a central injector 37, likewise hollow, provided at a lower end with cut-outs 38. A refrigerant fluid (such as water) introduced into the injector 37 passes through the cut-outs 38 and circulates between the injector 37 and the shell 36, in order to regulate the temperature thereof to a moderate value and thereby cool the preform 1, via its inner face, immediately after it has been formed.

The material (e.g. PET and/or rPET) is introduced in molten form, by means of an injection device (not shown) through a hole 29 made at the centre of the mold base 33.

Advantageously, the mold wall 35 and/or the outer wall of the outer shell of the core 34 has/have a surface condition configured to provide means suitable for reducing the intensity of the refracted ray and/or for modifying the angle of said refracted ray on the conical outer wall and/or, respectively, on the conical inner wall of the preforms 1.

It will be noted that, as an alternative, the preform 1 may be formed by techniques other than simple injection, in particular injection-compression.

It should be noted numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

1. A preform for manufacturing containers made of plastics material by stretch-blow molding, the preform comprising:
at least a body that is rotationally symmetrical about a vertical central axis, the body having an outer wall and an inner wall, the radial distance between the outer wall and the inner wall defining a wall thickness;
an open neck that extends as a continuation of the body from an upper end thereof, the neck being separated from the body by an annular collar; and
a base that closes the body from a lower end thereof, the base being rotationally symmetrical about the central axis, and the body having, over a cone height Hc, from the annular collar towards the base, a conical outer wall and/or a conical inner wall, wherein the conical outer wall and/or the conical inner wall comprises, over all or part of the cone height Hc, a means suitable for reducing the intensity of the refracted ray and/or for modifying the angle of the refracted ray,
wherein an incident radiation source is located outside the preform.

2. The preform according to claim 1, wherein the means suitable for reducing the refracted radiation and/or modifying the angle of the refracted ray comprise at least one surface condition of the conical outer wall and/or of the conical inner wall.

3. The preform according to claim 2, wherein the surface condition of the conical outer wall and/or of the conical inner wall comprise a matte surface of the conical outer wall and/or of the conical inner wall.

4. The preform according to claim 3, wherein the matte surface of the conical outer wall and/or of the conical inner wall has a roughness of between 0.1 and 1.5 μm.

5. The preform according to claim 2, wherein the surface condition of the conical outer wall and/or of the conical inner wall comprise a stepped surface of the conical outer wall and/or of the conical inner wall, each step comprising two segments.

6. The preform according to claim 5, wherein each step comprises two segments extending substantially perpendicularly to one another.

7. The preform according to claim 5, wherein each step comprises two segments, a first segment extending substantially perpendicularly to the axis of revolution of the preform and a second segment extending substantially parallel to the axis of revolution.

8. The preform according to claim 5, wherein each segment of each step is planar.

9. The preform according to claim 5, wherein at least one segment of each step is concave or convex.

10. The preform according to claim 1, wherein the means configured to reduce the intensity of the refracted ray and/or to modify the angle of the refracted ray of the conical outer wall and/or the conical inner wall extend over the entire cone height Hc.

11. A method for manufacturing a container by blow molding or stretch-blow molding, comprising at least the following steps:
providing a preform;
heating the body of the preform by exposure to monochromatic or quasi-monochromatic infrared radiation of predetermined intensity; and
forming the container by injecting a pressurized fluid into the preform preheated in this way,
wherein the preform comprises:
at least a body that is rotationally symmetrical about a vertical central axis, the body having an outer wall and an inner wall, the radial distance between the outer wall and the inner wall defining a wall thickness;
an open neck that extends as a continuation of the body from an upper end thereof, the neck being separated from the body by an annular collar; and
a base that closes the body from a lower end thereof, the base being rotationally symmetrical about the central axis, and the body having, over a cone height Hc, from the annular collar towards the base, a conical outer wall and/or a conical inner wall, wherein the conical outer wall and/or the conical inner wall comprises, over all or part of the cone height Hc, a means suitable for reducing the intensity of the refracted ray and/or for modifying the angle of the refracted ray, and
wherein an incident radiation source is located outside the preform.

12. The method according to claim 11, wherein between the heating step and the forming step, it comprises a step of introducing the preform into a mold shaped to match the container.

13. A mold for forming a preform, the mold comprising a mold body having a lateral wall shaped to match an outer face of the body of the preform and a mold base shaped to match an outer face of the base of the preform and a core shaped to match an inner face of the preform; and
wherein the preform comprises:
at least a body that is rotationally symmetrical about a vertical central axis, the body having an outer wall and an inner wall, the radial distance between the outer wall and the inner wall defining a wall thickness;
an open neck that extends as a continuation of the body from an upper end thereof, the neck being separated from the body by an annular collar; and
a base that closes the body from a lower end thereof, the base being rotationally symmetrical about the central axis, and the body having, over a cone height Hc, from the annular collar towards the base, a conical outer wall and/or a conical inner wall, wherein the conical outer wall and/or the conical inner wall comprises, over all or part of the cone height Hc, a means suitable for reducing the intensity of the refracted ray and/or for modifying the angle of the refracted ray.
